(19) United States
(12) Patent Application Publication
(10) Pub. No.: US 2009/0008855 A1
(43) Pub. Date: Jan. 8, 2009

(54) Sheet processing apparatus

(75) Inventor: Hirofumi Saito, Ibaraki (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Komori Corporation

(21) Appl. No.: 12/070,653

(22) Filed: Feb. 20, 2008

(30) Foreign Application Priority Data
Feb. 21, 2007 (JP) 040449/2007

(51) Int. Cl. B41F 13/08; G06F 7/00

(52) U.S. Cl. 270/19; 700/213

(57) ABSTRACT

A sheet processing apparatus includes a first cylinder, second cylinder, third cylinder, first driving device, second driving device, third driving device, and controller. The first cylinder receives a sheet from an upstream transport cylinder and holds the sheet. The second cylinder is disposed to oppose the first cylinder and prints/coats the sheet held by the first cylinder. The third cylinder is disposed to oppose the first cylinder and supplies ink/varnish to a circumferential surface of the first cylinder. The first driving device adjusts a gap amount between the first cylinder and upstream transport cylinder. The second driving device adjusts the position of the second cylinder with respect to the first cylinder. The third driving device adjusts the position of the third cylinder with respect to the first cylinder. The controller controls the second and third driving devices when the first driving device adjusts the gap amount between the first cylinder and upstream transport cylinder.

### BACKGROUND OF THE INVENTION

The present invention relates to a sheet processing apparatus which prints or coats the two surfaces, obverse, and reverse of a sheet.

Conventionally, as shown in Japanese Patent Laid-Open No. 2003-182031, a sheet processing apparatus has been proposed which comprises a blanket impression cylinder which opposes the last impression cylinder of a printing unit and receives a sheet from the last impression cylinder, a lower blanket cylinder which opposes the blanket impression cylinder in the upstream sheet convey direction of a position where the blanket cylinder opposes the last impression cylinder, and an upper blanket cylinder which opposes the blanket impression cylinder in the downstream sheet convey direction of the opposing point where the blanket impression cylinder opposes the last impression cylinder and supplies varnish to the surface of the sheet. As shown in Japanese Utility Model Registration No. 2,585,995, a sheet processing apparatus has been proposed in which an eccentric bearing supports a blanket cylinder opposing an impression cylinder and a cylinder throw on/off mechanism pivots the eccentric bearing to throw on/off the blanket cylinder.

In the conventional sheet processing apparatuses described above, when transferring a sheet from the last impression cylinder to the blanket impression cylinder, if the sheet is scratched depending on the thickness or material of the sheet to be processed, the packing combination of the blanket impression cylinder is changed to change the gap amount between the circumferential surfaces of the last impression cylinder and blanket impression cylinder. Accordingly, each time the sheet type changes, the packing combination of the blanket impression cylinder must be changed, which requires time. This increases the load to the operator to degrade the productivity.

When the packing combination of the blanket impression cylinder changes, the printing pressure between the blanket impression cylinder and upper blanket cylinder and that between the blanket impression cylinder and lower blanket cylinder change to degrade the printing quality. To prevent this, the eccentric bearings of the upper and lower blanket cylinders are pivoted, thus adjusting the printing pressures of the upper and lower blanket cylinders. As this adjustment must be performed repeatedly while checking the quality, a large amount of paper is wasted. Also, this adjustment must be performed each time the packing combination of the blanket impression cylinder changes, requiring time.

### SUMMARY OF THE INVENTION

It is an object of the present invention to provide a sheet processing apparatus in which an adjustment time to maintain the processing quality of a sheet is shortened to improve the productivity.

In order to achieve the above object, according to the present invention, there is provided a sheet processing apparatus comprising a first cylinder which receives a sheet from an upstream transport cylinder and holds the sheet, a second cylinder which is disposed to oppose the first cylinder and prints/coats the sheet held by the first cylinder, a third cylinder which is disposed to oppose the first cylinder and supplies ink/varnish to a circumferential surface of the first cylinder, first driving means for adjusting a gap amount between the first cylinder and the upstream transport cylinder, second driving means for adjusting a position of the second cylinder with respect to the first cylinder, third driving means for adjusting a position of the third cylinder with respect to the first cylinder, and control means for controlling the second driving means and the third driving means when the first driving means adjusts the gap amount between the first cylinder and the upstream transport cylinder.

### BRIEF DESCRIPTION OF THE DRAWINGS

FIG. 1 is a side view of a sheet-fed rotary printing press to which a sheet processing apparatus according to the present invention is applied;

FIG. 2 is a side view of the main part showing cylinder arrangement in the sheet-fed rotary printing press shown in FIG. 1;

FIG. 3 is a side view of the main part to describe the second and third driving devices which adjust the positions of an upper blanket cylinder and lower blanket cylinder shown in FIG. 1;

FIG. 4 is a view showing the connection state of the driving system of a motor for a coater double-diameter blanket cylinder shown in FIG. 1;

FIG. 5 is a view showing the connection state of the driving system of a motor for the upper blanket cylinder shown in FIG. 1;

FIG. 6 is a view showing the connection state of the driving system of a motor for the lower blanket cylinder shown in FIG. 1;

FIG. 7A is a block diagram showing the electrical arrangement of a sheet processing apparatus according to the first embodiment of the present invention;

FIG. 7B is a block diagram of a controller and gap amount input device shown in FIG. 7A;

FIG. 8A is a graph defining the relationship “between a gap amount t and a motor phase angle α” of the first conversion table shown in FIG. 7B;

FIG. 8B is a graph defining the relationship “between the motor phase angle α and a motor phase angle β with respect to a sheet thickness k” of the second conversion table shown in FIG. 7B;

FIG. 8C is a graph defining the relationship “between the motor phase angle α and a motor phase angle γ” of the third conversion table shown in FIG. 7B;

FIG. 8D is a graph defining the relationship “between the sheet thickness k and gap amount t” of the fourth conversion table shown in FIG. 7B;

FIGS. 9A to 9C are flowcharts for explaining the operation of adjusting the gap amount t and the operation of controlling printing pressures between respective cylinders in the sheet processing apparatus shown in FIG. 7A;

FIG. 10 is a block diagram showing the electrical arrangement of a sheet processing apparatus according to the second embodiment of the present invention;

FIG. 11A is a graph showing the relationship “between a sheet thickness k and motor phase angle α” of the first conversion table shown in FIG. 10;

FIG. 11B is a graph defining the relationship “between the motor phase angle α and a motor phase angle β” of the second conversion table shown in FIG. 10;

FIG. 11C is a graph defining the relationship “between the motor phase angle α and a motor phase angle γ” of the third conversion table shown in FIG. 10;

FIGS. 12A to 12C are flowcharts for explaining the operation of adjusting a gap amount t and the operation of controlling printing pressures between respective cylinders in the sheet processing apparatus shown in FIG. 10;

FIG. 13 is a block diagram showing the electrical arrangement of a sheet processing apparatus according to the third embodiment of the present invention;

FIG. 14A is a graph defining the relationship “between a gap amount t and motor phase angle α” of the first conversion table shown in FIG. 13;

FIG. 14B is a graph defining the relationship “between the motor phase angle α and a motor phase angle β with respect to a sheet thickness k” of the second conversion table shown in FIG. 13;

FIG. 14C is a graph defining the relationship “between the motor phase angle α and a motor phase angle γ” of the third conversion table shown in FIG. 13;

FIGS. 15A to 15D are flowcharts for explaining the operation of adjusting a gap amount t and the operation of controlling printing pressures between respective cylinders in the sheet processing apparatus shown in FIG. 13;

FIG. 16 is a block diagram showing the electrical arrangement of a sheet processing apparatus according to the fourth embodiment of the present invention;

FIG. 17 is a block diagram showing the electrical arrangement of a sheet processing apparatus according to the fifth embodiment of the present invention;

FIG. 18 is a diagram showing a data sequence in the sheet processing apparatus according to the first embodiment of the present invention; and

FIG. 19 is a diagram showing a data sequence in the sheet processing apparatus according to the second embodiment of the present invention.

### DESCRIPTION OF THE PREFERRED EMBODIMENTS

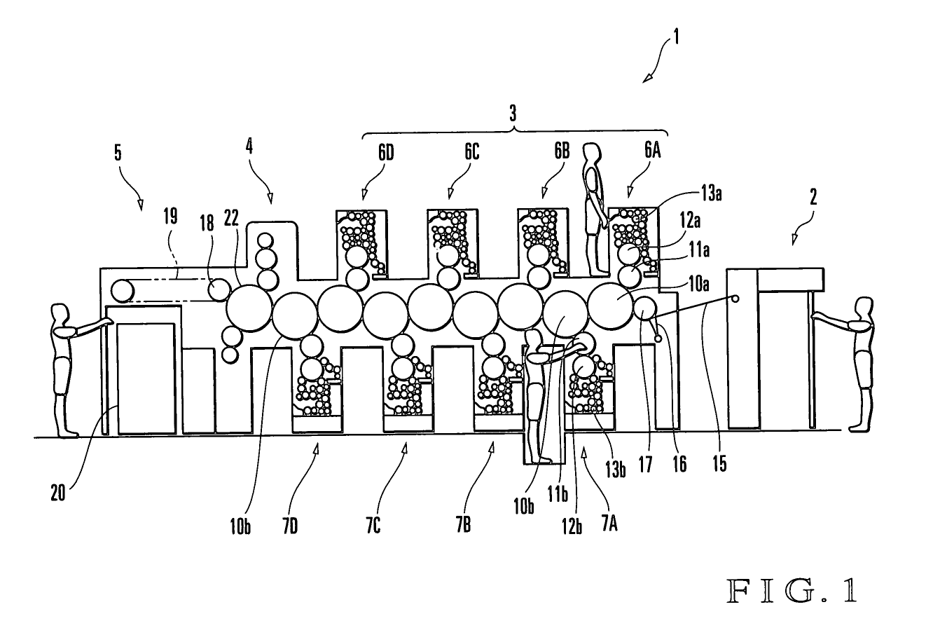

A sheet processing apparatus according to the first embodiment of the present invention will be described with reference to FIGS. 1 to 9C.

As shown in FIG. 1, a sheet-fed rotary printing press 1 to which a sheet processing apparatus according to the first embodiment is applied comprises a feeder 2 for feeding a sheet, a printing unit 3 serving as a liquid transfer device which prints the sheet fed from the feeder 2, a coating unit 4 serving as a liquid transfer device which coats with varnish one or both of the obverse and reverse of the sheet printed by the printing unit 3, and a delivery unit 5 serving as a delivery unit to which the sheet coated by the coating unit 4 is delivered. The printing unit 3 comprises first to fourth obverse printing units 6A to 6D serving as an obverse processing unit, and first to fourth reverse printing units 7A to 7D serving as a reverse processing unit.

Each of the obverse printing units 6A to 6D comprises a double-diameter impression cylinder 10a (convey means) serving as a transport cylinder which has grippers (sheet holding means) for gripping a sheet in its peripheral portion, a blanket cylinder 11a serving as a transfer cylinder which opposes the upper portion of the impression cylinder 10a, a plate cylinder 12a which opposes the upper portion of the blanket cylinder 11a, and an inking unit 13a serving as a liquid supply unit which supplies ink as a liquid to the plate cylinder 12a.

Each of the reverse printing units 7A to 7D comprises a double-diameter impression cylinder 10b (convey means) serving as a transport cylinder which has grippers (sheet holding means) for gripping a sheet in its peripheral portion, a blanket cylinder 11b serving as a transfer cylinder which opposes the lower portion of the impression cylinder 10b, a plate cylinder 12b which opposes the lower portion of the blanket cylinder 11b, and an inking unit 13b serving as a liquid supply unit which supplies ink as a liquid to the plate cylinder 12b.

The sheet processing apparatus according to this embodiment comprises the printing unit 3 including the four obverse printing units 6A to 6D and four reverse printing units 7A to 7D, and the coating unit 4 disposed in the downstream sheet convey direction of the printing unit 3. The impression cylinders 10a of the obverse printing units 6A to 6D oppose the impression cylinders 10b of the reverse printing units 7A to 7D, respectively.

In this arrangement, the leading edge of a sheet supplied from the feeder 2 onto a feeder board 15 is gripped by a swing arm shaft pregripper 16 and gripping-changed to the grippers of the impression cylinder 10a of the first obverse printing unit 6A. The sheet gripped by the grippers of the impression cylinder 10a is printed in the first color as it passes between the impression cylinder 10a and blanket cylinder 11a. The sheet the obverse of which is printed in the first color is gripping-changed to the impression cylinder 10b of the first reverse printing unit 7A, and is printed in the first color on its reverse as it passes between the impression cylinder 10b and blanket cylinder 11b.

Subsequently, second to fourth obverse printing units 6B to 6D and second to fourth reverse printing units 7B to 7D print in the second to fourth colors. The coating unit 4 coats the sheet, which is printed in four colors on each of its obverse and reverse, with varnish as a liquid. The coated sheet is gripping-changed to the delivery grippers (sheet holding means; not shown) of a delivery chain 19 (convey means) of the delivery unit 5, is conveyed by the delivery chain 19, and falls on a delivery pile 20 and piles there.

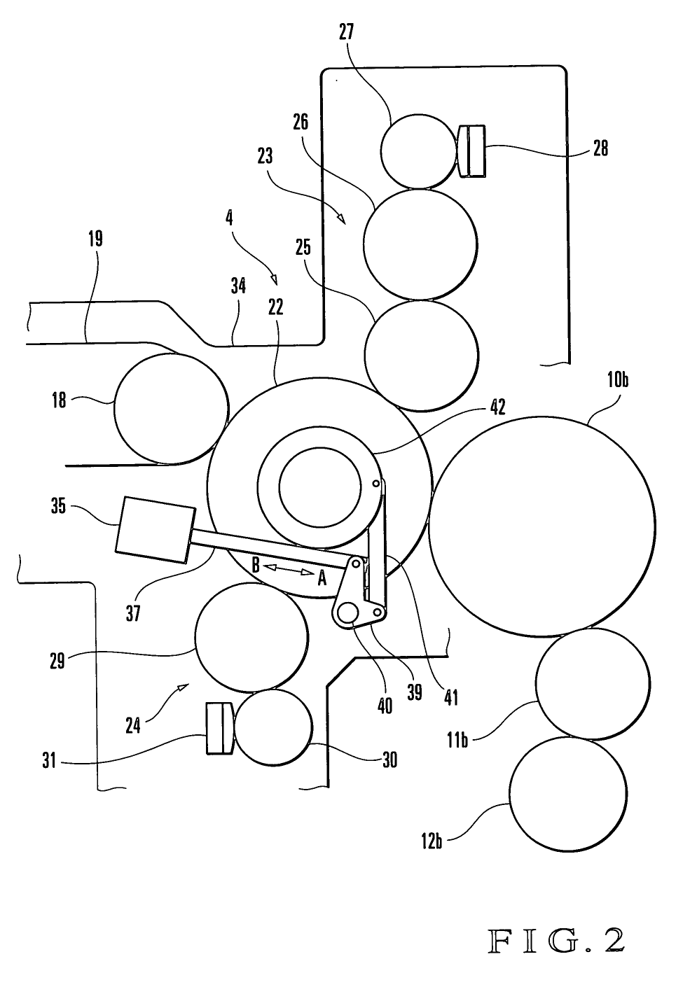

As shown in FIG. 2, the coating unit 4 comprises a coater double-diameter blanket cylinder 22 (first cylinder) serving as a reverse processing cylinder which opposes the impression cylinder 10b serving as the transport cylinder of the fourth reverse printing unit 7D. The coating unit 4 further comprises a first varnish coating device 23 (obverse processing means) which coats the obverse of the printed sheet, and a second varnish coating device 24 (reverse processing means) which coats the reverse of the printed sheet.

The first varnish coating device 23 comprises an upper blanket cylinder 25 (second cylinder) serving as an obverse processing cylinder which is disposed in the downstream sheet convey direction of a transfer point where the sheet held by the impression cylinder 10b is transferred to the coater double-diameter blanket cylinder 22, i.e., the opposing point of the coater double-diameter blanket cylinder 22 and impression cylinder 10b, and opposes the coater double-diameter blanket cylinder 22, a varnish film formation cylinder 26 which opposes the upper blanket cylinder 25, an anilox roller 27 which opposes the varnish film formation cylinder 26, and a chamber coater 28 which supplies varnish to the anilox roller 27. The anilox roller 27 and chamber coater 28 constitute an obverse liquid supply means.

The varnish supplied from the chamber coater 28 to the anilox roller 27 is transferred to the upper blanket cylinder 25 through the varnish film formation cylinder 26 and coats the printed obverse of the sheet passing between the upper blanket cylinder 25 and coater double-diameter blanket cylinder 22. When the sheet passes between the upper blanket cylinder 25 and coater double-diameter blanket cylinder 22, the varnish transferred from a lower blanket cylinder 29 (third cylinder) serving as the reverse blanket cylinder of the second varnish coating device 24 to the circumferential surface of the coater double-diameter blanket cylinder 22 coats the printed reverse of the sheet with the printing pressure of the upper blanket cylinder 25.

The second varnish coating device 24 comprises the lower blanket cylinder 29 which is disposed in the upstream rotational direction of the coater double-diameter blanket cylinder 22 of the opposing point of the coater double-diameter blanket cylinder 22 and impression cylinder 10b and opposes the coater double-diameter blanket cylinder 22, an anilox roller 30 which opposes the lower blanket cylinder 29, and a chamber coater 31 which supplies the varnish to the anilox roller 30. The varnish supplied from the chamber coater 31 to the anilox roller 30 is transferred to the circumferential surface of the coater double-diameter blanket cylinder 22 through the lower blanket cylinder 29. The anilox roller 30 and chamber coater 31 constitute a reverse liquid supply means.

As shown in FIG. 4, a motor 35 (first driving means) for the coater double-diameter blanket cylinder which is attached to the frames 34 is connected to one end of a rod 37 through a gear train 36. When the motor 35 is driven in one direction, the rod 37 moves in the direction of an arrow A in FIG. 2 through the gear train 36. When the motor 35 is driven in the opposite direction, the rod 37 moves in the direction of an arrow B in FIG. 2 through the gear train 36. A potentiometer 38 (detection means) for the coater double-diameter blanket cylinder detects the current position of the coater double-diameter blanket cylinder 22. A controller 67 (to be described later) detects (calculates) a phase angle α of the motor 35 on the basis of an output from the potentiometer 38.

As shown in FIG. 2, an almost L-shaped lever 39 is fixed to one end of a shaft 40 which is rotatably supported between the pair of frames 34. One end of the lever 39 is pivotally mounted on the other end of the rod 37, and its other end is pivotally mounted on one end of a rod 41. A lever (not shown) is fixed to the other end of the shaft 40. An end of the lever is pivotally mounted on one end of a rod (not shown). The other end of this rod is pivotally mounted on an eccentric bearing (to be described later) which rotatably supports the other end shaft of the coater double-diameter blanket cylinder 22.

A pair of eccentric bearings 42 which rotatably support the two end shafts of the coater double-diameter blanket cylinder 22 are fitted on the pair of frames 34. The other end of the rod 41 is pivotally mounted on the corresponding eccentric bearing 42. In this arrangement, when the rod 37 moves in the direction of the arrow A and the lever 39 accordingly pivots clockwise about the shaft 40 as the center, the coater double-diameter blanket cylinder 22 separates from the impression cylinder 10b through the rod 41 and the corresponding eccentric bearing 42. This increases the gap amount between the circumferential surfaces of the coater double-diameter blanket cylinder 22 and impression cylinder 10b.

When the rod 37 moves in the direction of the arrow B and the lever 39 accordingly pivots counterclockwise about the shaft 40 as the center, the coater double-diameter blanket cylinder 22 moves close to the impression cylinder 10b through the rod 41 and the corresponding eccentric bearing 42. This decreases the gap amount between the circumferential surfaces of the coater double-diameter blanket cylinder 22 and impression cylinder 10b.

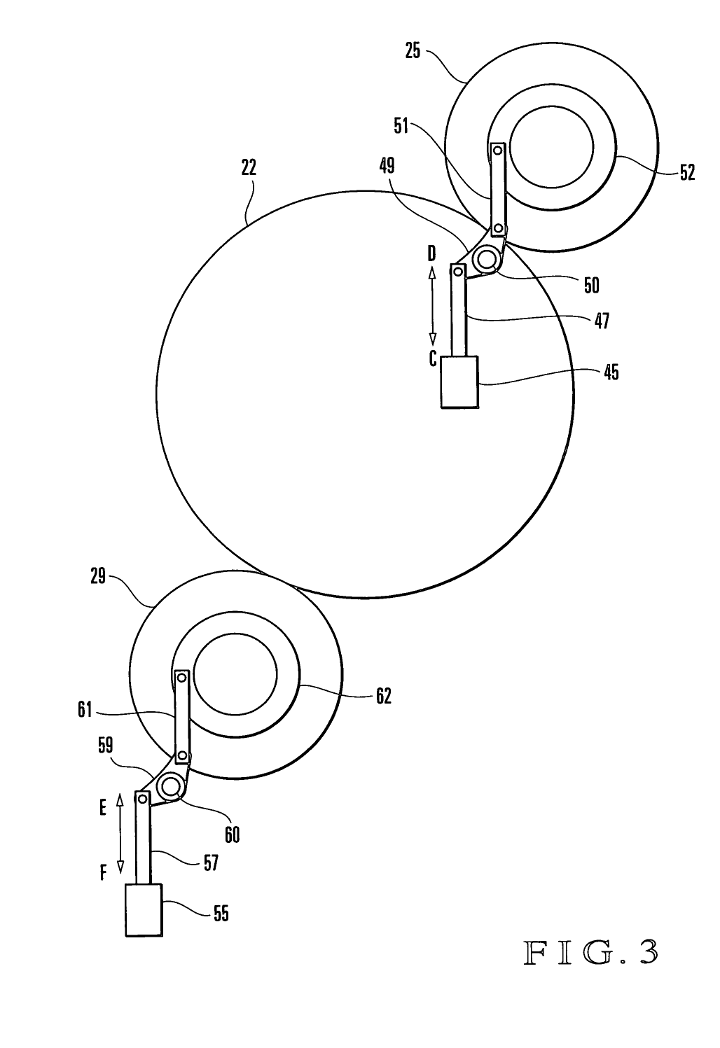

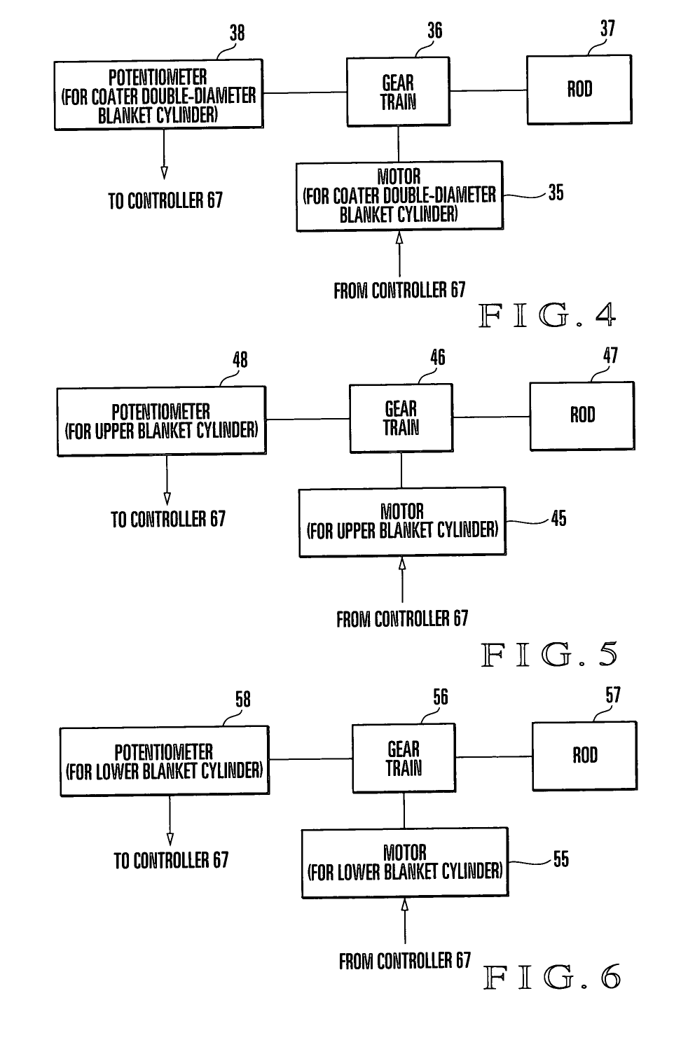

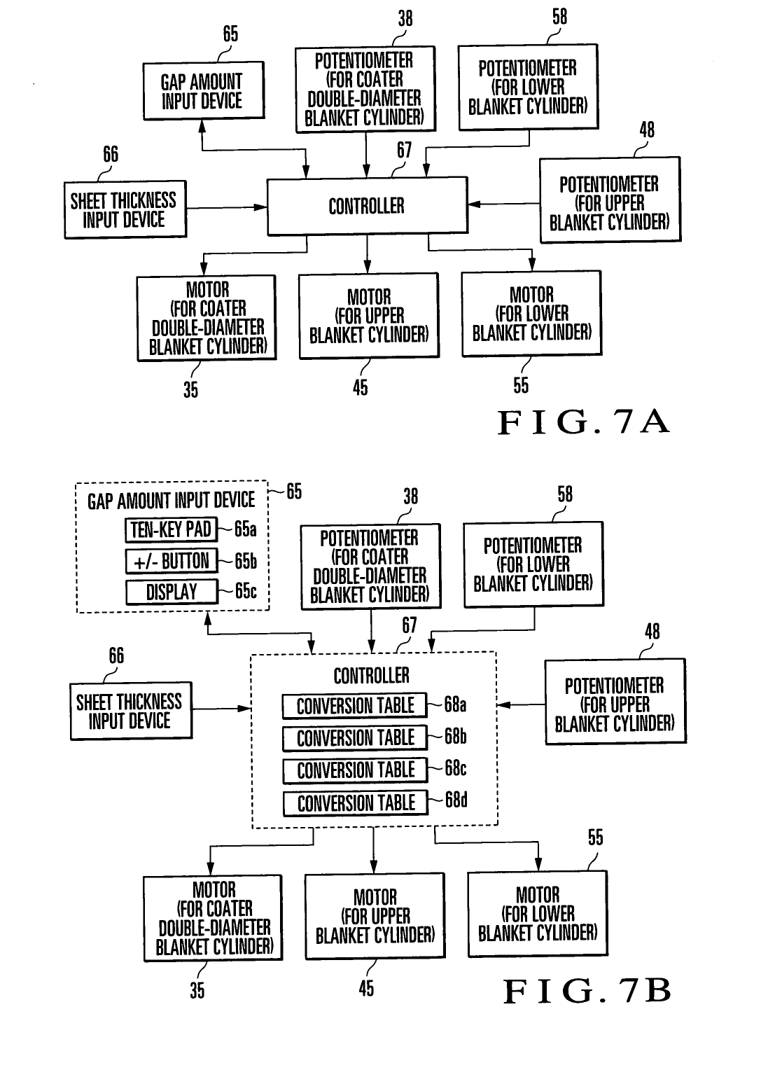

As shown in FIG. 3, a motor 45 (second driving means) for the upper blanket cylinder is attached to the frames 34. As shown in FIG. 5, the motor 45 is connected to one end of a rod 47 through a gear train 46. When the motor 45 is driven in one direction, the rod 47 moves in the direction of an arrow C in FIG. 3 through the gear train 46. When the motor 45 is driven in the opposite direction, the rod 47 moves in the direction of an arrow D in FIG. 3 through the gear train 46. A potentiometer 48 for the upper blanket cylinder detects the current position of the upper blanket cylinder 25 and outputs it to the controller 67 (FIG. 7A). The controller 67 detects (calculates) a phase angle β of the motor 45 on the basis of an output from the potentiometer 48.

As shown in FIG. 3, an almost L-shaped lever 49 is fixed to one end of a shaft 50 which is rotatably supported between the pair of frames 34. One end of the lever 49 is pivotally mounted on the other end of the rod 47, and its other end is pivotally mounted on one end of a rod 51. A lever (not shown) is fixed to the other end of the shaft 50. An end of the lever is pivotally mounted on one end of a rod (not shown). The other end of this rod is pivotally mounted on an eccentric bearing (to be described later) which rotatably supports the other end shaft of the upper blanket cylinder 25.

A pair of eccentric bearings 52 which rotatably support the two end shafts of the upper blanket cylinder 25 are fitted on the pair of frames 34. The other end of the rod 51 is pivotally mounted on the corresponding eccentric bearing 52. When the rod 47 moves in the direction of the arrow C and the lever 49 accordingly pivots counterclockwise about the shaft 50 as the center, the upper blanket cylinder 25 moves close to the coater double-diameter blanket cylinder 22 through the rod 51 and the corresponding eccentric bearing 52. This decreases the gap amount between the circumferential surfaces of the coater double-diameter blanket cylinder 22 and upper blanket cylinder 25.

When the rod 47 moves in the direction of the arrow D and the lever 49 accordingly pivots clockwise about the shaft 50 as the center, the upper blanket cylinder 25 separates from the coater double-diameter blanket cylinder 22 through the rod 51 and the corresponding eccentric bearing 52. This increases the gap amount between the circumferential surfaces of the coater double-diameter blanket cylinder 22 and upper blanket cylinder 25.

As shown in FIG. 3, a motor 55 (third driving means) for the lower blanket cylinder is attached to the frames 34. As shown in FIG. 6, the motor 55 is connected to one end of a rod 57 through a gear train 56. When the motor 55 is driven in one direction, the rod 57 moves in the direction of an arrow E in FIG. 3 through the gear train 56. When the motor 55 is driven in the opposite direction, the rod 57 moves in the direction of an arrow F in FIG. 3 through the gear train 56. A potentiometer 58 for the lower blanket cylinder detects the current position of the lower blanket cylinder 29 and outputs it to the controller 67 (FIG. 7A). The controller 67 detects (calculates) a phase angle γ of the motor 55 on the basis of an output from the potentiometer 58.

As shown in FIG. 3, an almost L-shaped lever 59 is fixed to one end of a shaft 60 which is rotatably supported between the pair of frames 34. One end of the lever 59 is pivotally mounted on the other end of the rod 57, and its other end is pivotally mounted on one end of a rod 61. A lever (not shown) is fixed to the other end of the shaft 60. An end of the lever is pivotally mounted on one end of a rod (not shown). The other end of this rod is pivotally mounted on an eccentric bearing (to be described later) which rotatably supports the other end shaft of the lower blanket cylinder 29.

A pair of eccentric bearings 62 which rotatably support the two end shafts of the lower blanket cylinder 29 are fitted on the pair of frames 34. The other end of the rod 61 is pivotally mounted on the corresponding eccentric bearing 62. When the rod 57 moves in the direction of the arrow E, the lever 59 pivots clockwise about the shaft 60 as the center. Thus, the lower blanket cylinder 29 moves toward the coater double-diameter blanket cylinder 22 through the rod 61 and the corresponding eccentric bearing 62. This increases the printing pressure between the coater double-diameter blanket cylinder 22 and lower blanket cylinder 29.

When the rod 57 moves in the direction of the arrow F, the lever 59 pivots counterclockwise about the shaft 50 as the center. Thus, the lower blanket cylinder 29 separates from the coater double-diameter blanket cylinder 22 through the rod 61 and the corresponding eccentric bearing 62. This decreases the printing pressure between the coater double-diameter blanket cylinder 22 and lower blanket cylinder 29.

The sheet processing apparatus according to this embodiment comprises, in addition to the potentiometers 38, 48, and 58 and motors 35, 45, and 55 described above, the controller 67 (control means), a gap amount input device 65, and a sheet thickness input device 66, as shown in FIG. 7A. The controller 67 is connected to the potentiometers 38, 48, and 58, motors 35, 45, and 55, gap amount input device 65, and sheet thickness input device 66. A gap amount t between the coater double-diameter blanket cylinder 22 and impression cylinder 10b is input to the gap amount input device 65, and the thickness of the sheet to be conveyed is input to the sheet thickness input device 66. The input devices 65 and 66 comprise a key input device to which numerical values are input by the operator's key operation.

Of these constituent members, as shown in FIG. 7B, the gap amount input device 65 comprises a ten-key pad 65a to which the numerical value of the gap amount t is input, a +/− button 65b which changes (increases or decreases) the input (displayed) gap amount t, and a display 65c which displays the value of the input or changed gap amount t. The gap amount t to be displayed on the display 65c is input from the sheet thickness input device 66, ten-key pad 65a, and +/− button 65b which are manipulated by the operator. More specifically, when the operator inputs a sheet thickness k from the key input device (not shown) of the sheet thickness input device 66, the controller 67 converts the sheet thickness k input from the sheet thickness input device 66 into the gap amount t by looking up the fourth table (to be described later), and displays the gap amount t on the display 65c.

When the operator inputs the gap amount t from the ten-key pad 65a, the controller 67 displays (sets) the gap amount t input from the sheet thickness input device 66 on the display 65c. When the operator adjusts the displayed (set) gap amount t using the +/− button 65b, the controller 67 displays the adjusted gap amount t on the display 65c. When the sheet thickness is changed from k1 to k2, the operator inputs the sheet thickness k2 to the sheet thickness input device 66. The controller 67 changes the gap amount from t1 to t2 using the input sheet thickness k2 and the fourth table (to be described later), and displays the gap amount t2 on the display 65c.

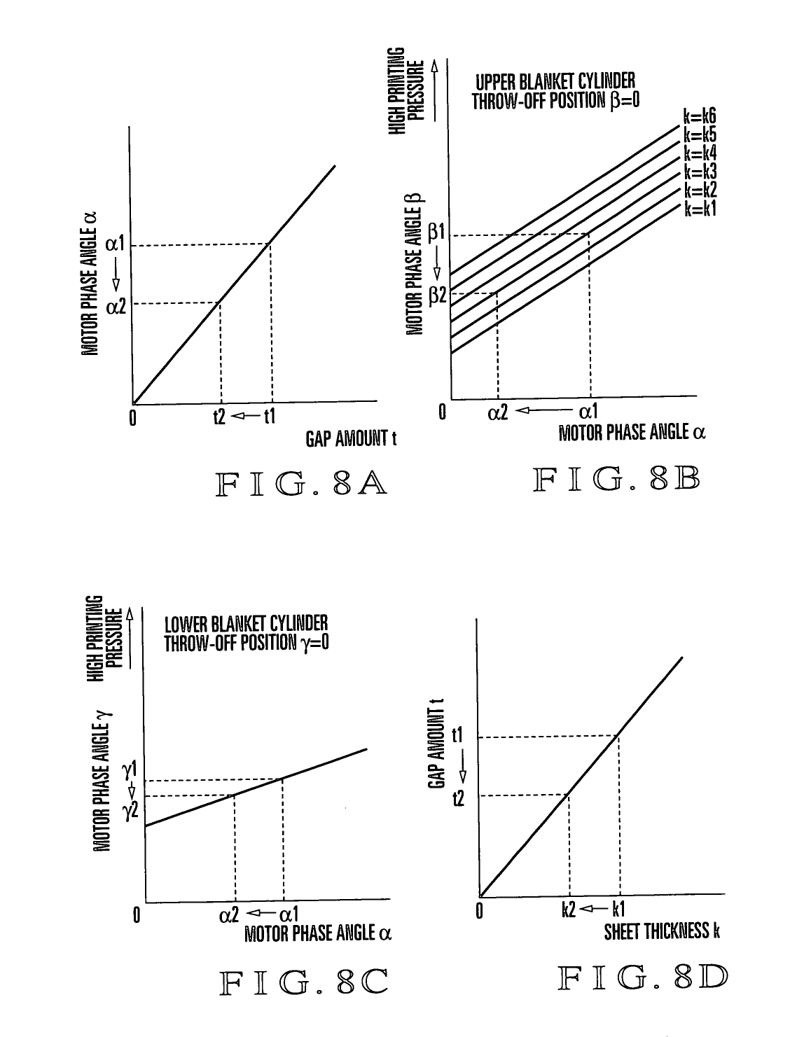

As shown in FIG. 7B, the controller 67 has a first conversion table 68a showing the relationship “between the gap amount t and the phase angle α of the motor 35” (FIG. 8A), a second conversion table 68b defining the relationship “between the phase angle α of the motor 35 and the phase angle β of the motor 45 with respect to the sheet thickness k” (FIG. 8B), a third conversion table 68c defining the relationship “between the phase angle α of the motor 35 and the phase angle γ of the motor 55” (FIG. 8C), and a fourth conversion table 68d defining the relationship “between the sheet thickness k and gap amount t” (FIG. 8D). As shown in FIG. 8D, the controller 67 converts the sheet thickness k input from the key input device (not shown) of the sheet thickness input device 66 into the gap amount t by looking up the fourth conversion table 68d as described above. The conversion table 68d may be provided to the sheet thickness input device 66 or gap amount input device 65.

The controller 67 controls the phase angle α of the motor 35 on the basis of an output from the conversion table 68a which corresponds to the gap amount t2 input (set) in the gap amount input device 65, and the output from the potentiometer 38. The controller 67 controls the phase angle β of the motor 45 on the basis of an output from the conversion table 68b which corresponds to a sheet thickness k3 input to the sheet thickness input device 66 and a phase angle α2 of the motor 35, and the output from the potentiometer 48. The controller 67 controls the phase angle γ of the motor 55 on the basis of an output from the conversion table 68c which corresponds to the phase angle α2 of the motor 35, and the output from the potentiometer 58.

The conversion tables concerning the phase angles of the respective motors 35, 45, and 55 will be described in detail with reference to FIGS. 8A to 8C. Upon reading the gap amount t=t1 from the gap amount input device 65, the controller 67 obtains a phase angle α1 of the motor 35, as shown in FIG. 8A, by looking up the conversion table 68a. When the gap amount is changed from t1 to t2, the controller 67 changes the phase angle of the motor 35 from α1 to α2 by looking up the conversion table 68a.

This will be described in more detail. When transferring the sheet from the impression cylinder 10b to the coater double-diameter blanket cylinder 22, the sheet may be scratched. In this case, to prevent a scratch, the gap amount t1 between the impression cylinder 10b and coater double-diameter blanket cylinder 22 is changed to t2. The change to the gap amount t2 is performed by changing the phase angle of the motor 35 from α1 to α2. In this example, as a countermeasure for a scratch, the gap amount t is changed in the decreasing direction. Alternatively, the gap amount t is changed in the increasing direction. When adjusting the gap amount t, the gap amount t is increased or decreased selectively in accordance with the conditions of the sheet, such as the quality or stiffness, and the location of the scratch.

When the gap for the coater double-diameter blanket cylinder 22 is adjusted as described above, the printing pressure between the coater double-diameter blanket cylinder 22 and upper blanket cylinder 25 changes from that obtained before gap adjustment. In order to maintain the printing pressure between the two cylinders 22 and 25 obtained before gap adjustment, the controller 67 obtains the phase angle β of the motor 45 from the phase angle α of the motor 35 and the sheet thickness k, as shown in FIG. 8B, by looking up the conversion table 68b. When the sheet thickness k=k3 and the phase angle of the motor 35 is α1, a phase angle β1 of the motor 45 is obtained from the conversion table 68b. Note that the sheet thickness k is a value input to the sheet thickness input device 66.

As the phase angle of the motor 35 is changed from α1 to α2, the phase angle of the motor 45 is also changed from β1 to β2. In this manner, when the phase angle of the motor 35 is changed to α2 and the phase angle of the motor 45 is changed to β2, the printing pressure between the coater double-diameter blanket cylinder 22 and upper blanket cylinder 25 which is obtained after the change is set to be equal to that obtained before the change.

When the gap for the coater double-diameter blanket cylinder 22 is adjusted as described above, the printing pressure between the coater double-diameter blanket cylinder 22 and lower blanket cylinder 29 changes from that obtained before gap adjustment. In order to maintain the printing pressure between the two cylinders 22 and 29 obtained before gap adjustment, the controller 67 obtains the phase angle γ of the motor 55 from the phase angle α of the motor 35, as shown in FIG. 8C, by looking up the conversion table 68c. More specifically, when the phase angle of the motor 35 is α1, a phase angle γ1 of the motor 55 is obtained from the conversion table 68c.

As the phase angle of the motor 35 is changed from α1 to α2, the phase angle of the motor 55 is also changed from γ1 to γ2. In this manner, when the phase angle of the motor 35 is changed to α2 and the phase angle of the motor 55 is changed to γ2, the printing pressure between the coater double-diameter blanket cylinder 22 and lower blanket cylinder 29 which is obtained after the change is set to be equal to that obtained before the change.

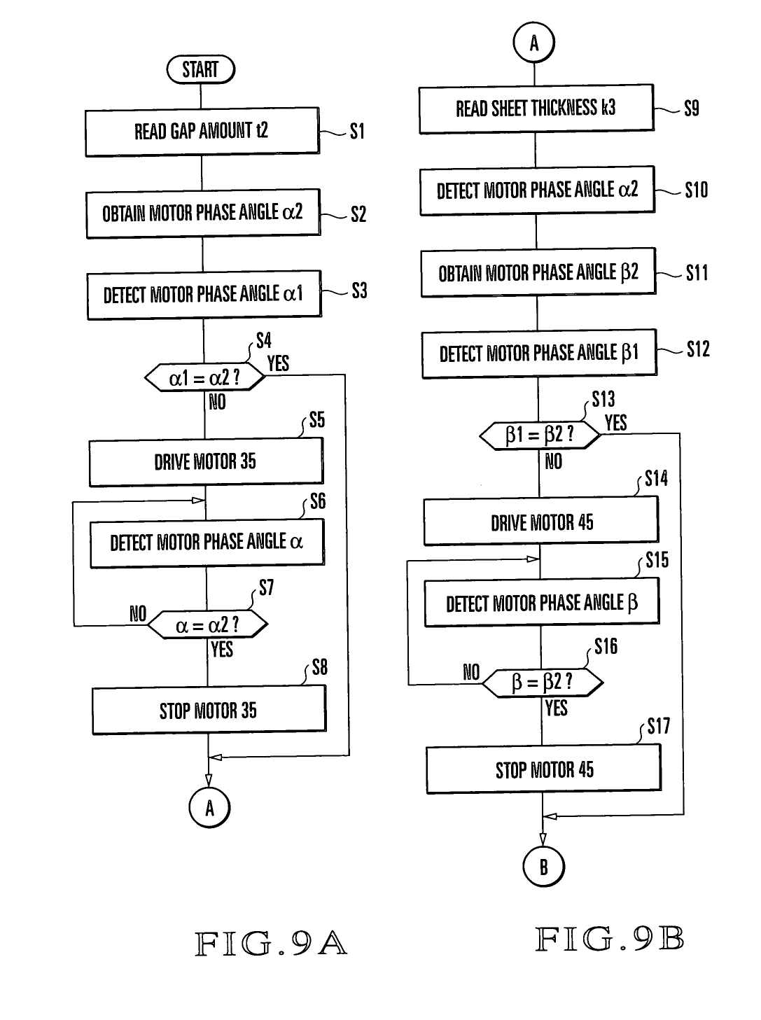

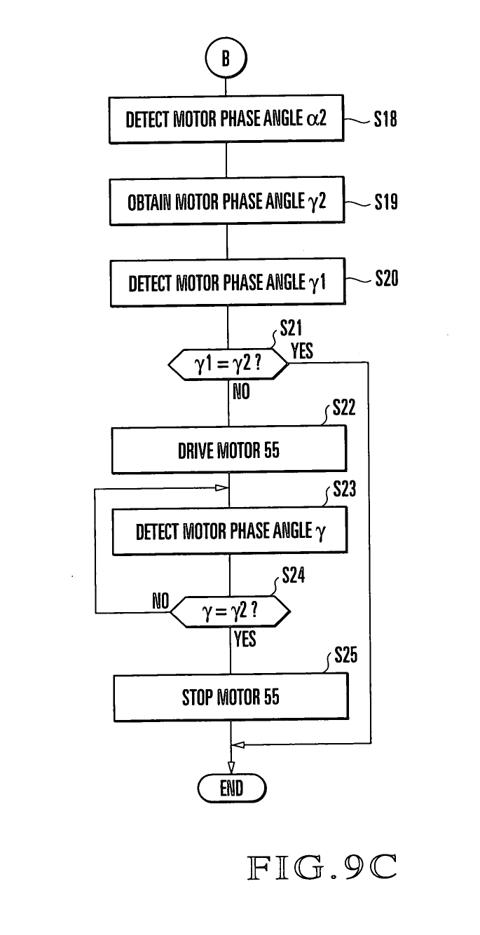

The operation of adjusting the gap amount between the coater double-diameter blanket cylinder 22 and impression cylinder 10b and the operation of controlling the printing pressure between the coater double-diameter blanket cylinder 22 and upper blanket cylinder 25 or lower blanket cylinder 29 in the sheet processing apparatus having the above arrangement will be described with reference to FIGS. 9A to 9C.

First, the controller 67 reads the gap amount t2 input to the gap amount input device 65 (step S1). The controller 67 obtains the phase angle α2 of the motor 35 from the readout gap amount t2 by looking up the conversion table 68a (step S2). The controller 67 then detects the current phase angle α1 of the motor 35 on the basis of the output from the potentiometer 38 (step S3).

Then, the phase angles α1 and α2 are compared (step S4). If α1=α2, the phase angle α of the motor 35 is the phase angle α2 obtained from the gap amount t2. Thus, the motor 35 is not driven, and the process advances to step S9.

If NO in step S4, the motor 35 is driven (step S5). The current phase angle α of the motor 35 is detected on the basis of the output from the potentiometer 38 (step S6). If α=α2 (YES in step S7), the motor 35 is stopped (step S8). Thus, the coater double-diameter blanket cylinder 22 is adjusted to the position where its gap amount with respect to the impression cylinder 10b is t2.

If NO in step S7, the motor 35 is kept driven, and steps S6 and S7 are repeated until α=α2 is obtained. Namely, the controller 67 controls the motor 35 such that the current motor phase angle detected from the potentiometer 38 becomes the phase angle obtained from the conversion table 68a.

The controller 67 then reads the sheet thickness k=k3 input to the sheet thickness input device 66 (step S9). The current phase angle α2 of the motor 35 controlled through steps S4 to S8 is detected on the basis of the output from the potentiometer 38 (step S10). The controller 67 obtains the phase angle β2 of the motor 45 from the sheet thickness k3 and the phase angle α2 of the motor 35 by looking up the conversion table 68b (step S11).

In steps S4 to S8, the motor 35 is controlled to have the phase angle α2, and in step S7, it is detected that the motor 35 has the phase angle α2. Thus, step S10 can be eliminated.

The controller 67 then detects the current phase angle β1 of the motor 45 on the basis of the output from the potentiometer 48 (step S12). The current phase angle β1 of the motor 45 is compared with the phase angle β2 of the motor 45 which is obtained from the phase angle α2 of the motor 35 and the sheet thickness k=k3 (step S13). If β1=β2, the phase angle β of the motor 45 is the phase angle β2 obtained from the phase angle α2 of the motor 35. Thus, the motor 45 is not driven, and the process advances to step S18.

If NO in step S13, the motor 45 is driven (step S14). The current phase angle β of the driven motor 45 is detected on the basis of the output from the potentiometer 48 (step S15). If β=β2 (YES in step S16), the motor 45 is stopped (step S17). Thus, the upper blanket cylinder 25 is positionally adjusted to maintain its printing pressure with respect to the coater double-diameter blanket cylinder 22 which is obtained before position adjustment.

If NO in step S16, the motor 45 is kept driven, and steps S15 and S16 are repeated until β=β2 is obtained.

The controller 67 then detects the current phase angle α2 of the motor 35 controlled through step S4 to step S8 (step S18). The controller 67 obtains the phase angle γ2 of the motor 55 from the phase angle α2 of the motor 35 by looking up the conversion table 68c (step S19).

In steps S4 to S8, the motor 35 is controlled to have the phase angle α2, and in step S7, it is detected that the motor 35 has the phase angle α2. Thus, step S18 can be eliminated.

The controller 67 then detects the current phase angle γ1 of the motor 55 on the basis of the output from the potentiometer 58 (step S20). The current phase angle γ1 of the motor 55 is compared with the phase angle γ2 of the motor 55 which is obtained from the phase angle α2 of the motor 35 (step S21). If γ1=γ2, the phase angle γ of the motor 55 is the phase angle γ2 obtained from the phase angle α2 of the motor 35. Thus, the motor 55 is not driven, and the control operation is ended.

If NO in step S21, the motor 55 is driven (step S22). The controller 67 detects the current phase angle γ of the driven motor 55 on the basis of the output from the potentiometer 58 (step S23). If γ=γ2 (YES in step S24), the motor 55 is stopped (step S25).

If NO in step S24, the motor 55 is kept driven, and steps S23 and S24 are repeated until γ=γ2 is obtained. Thus, the lower blanket cylinder 29 is positionally adjusted to maintain its printing pressure with respect to the coater double-diameter blanket cylinder 22 which is obtained before position adjustment.

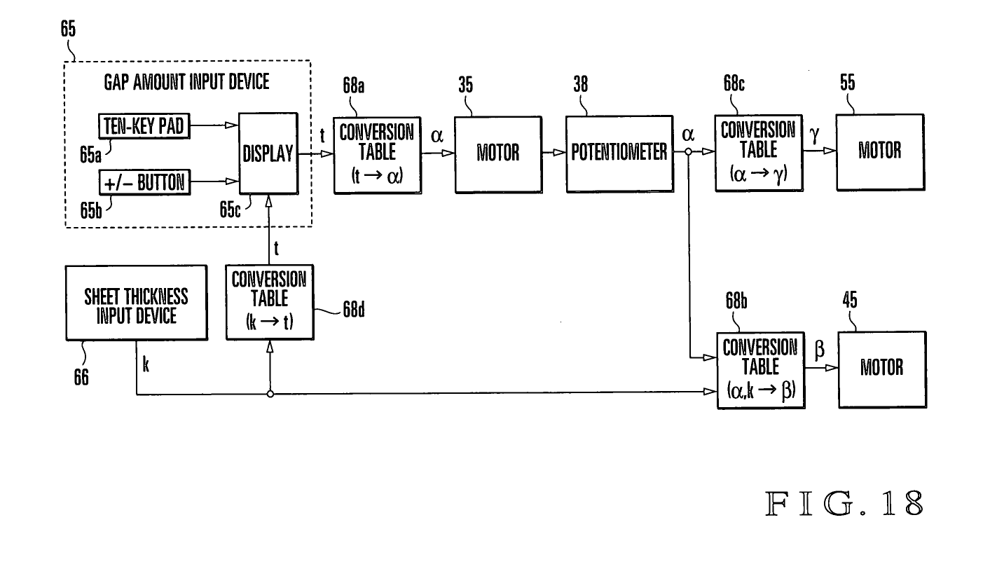

The data sequence of this embodiment will be described with reference to FIG. 18. First, the sheet thickness k is input to the sheet thickness input device 66. In the conversion table 68d, the sheet thickness k input from the sheet thickness input device 66 is converted into the gap amount t. The display 65c of the gap amount input device 65 displays the gap amount t. By input operation from the ten-key pad 65a of the gap amount input device 65, the gap amount t is directly input, or the gap amount t converted from the sheet thickness k is changed. The display 65c displays the gap amount t input or changed by the ten-key pad 65a. The +/− button 65b is manipulated to finely adjust the gap amount t displayed on the display 65c. In the conversion table 68a, the phase angle α is obtained from the gap amount t displayed on the display 65c. The motor 35 is driven to have the phase angle α obtained from the conversion table 68a.

Upon detecting that the phase angle of the motor 35 has become α, the potentiometer 38 outputs the phase angle α to the conversion tables 68b and 68c. In the conversion table 68b, the phase angle β is obtained from the phase angle α detected by the potentiometer 38 and the sheet thickness k input from the sheet thickness input device 66. In the conversion table 68c, the phase angle γ is obtained from the phase angle α detected by the potentiometer 38. The motors 45 and 55 are driven to have the phase angles β and γ obtained from the conversion tables 68b and 68c, respectively.

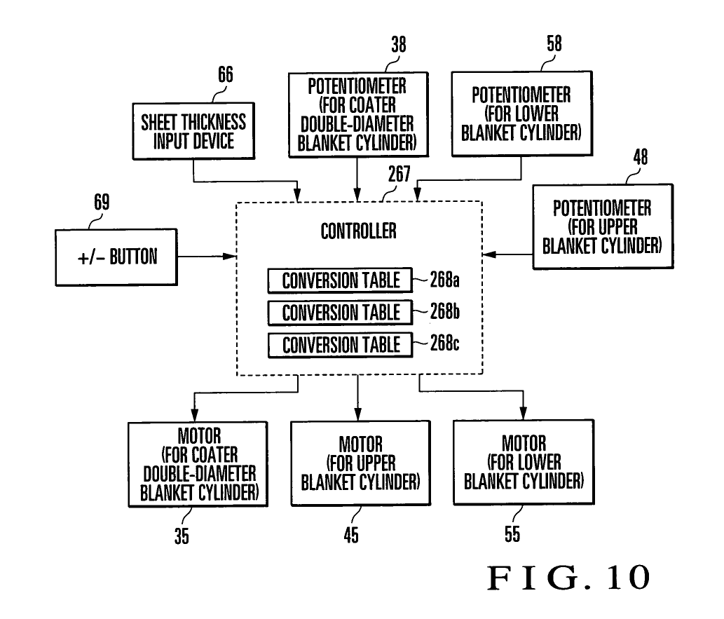

The second embodiment of the present invention will be described with reference to FIGS. 10 to 12C. According to the second embodiment, a phase angle α of a motor 35 is obtained on the basis of a sheet thickness k input to a sheet thickness input device 66, and a phase angle β of a motor 45 and a phase angle γ of a motor 55 for a lower blanket cylinder are obtained on the basis of the phase angle α of the motor 35 detected by a potentiometer 38. As shown in FIG. 10, a controller 267 comprises first to third conversion tables 268a, 268b, and 268c.

According to this embodiment, unlike the first embodiment, the controller 267 comprises a +/− button 69 in place of a gap amount input device. When the operator manipulates the +/− button 69, the controller 267 drives the motor 35 clockwise/counterclockwise for a predetermined rotation count to directly adjust a gap amount t. Namely, the +/− button 69 finely adjusts the phase angle α obtained on the basis of the sheet thickness k. During the manipulation of the +/− button 69, the motor 35 may be driven. The other elements shown in FIG. 10 are identical to those shown in FIG. 7A, and a repetitive explanation will be omitted.

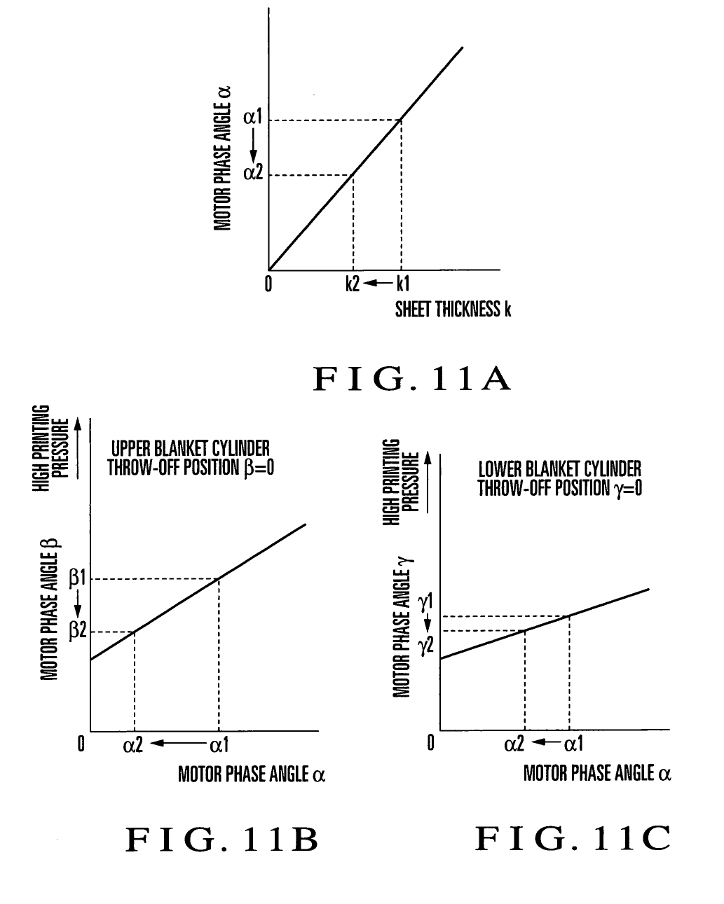

The conversion table 268a shows the relationship “between the sheet thickness k and the phase angle α of the motor 35”, as shown in FIG. 11A. The controller 267 controls the phase angle α of the motor 35 on the basis of an output from the conversion table 268a which corresponds to the sheet thickness k, and an output from the potentiometer 38. When the sheet thickness satisfies k=k1, a phase angle α1 of the motor 35 is obtained from the conversion table 268a. When the sheet thickness is changed from k1 to k2, the phase angle is also changed from α1 to α2.

This is due to the following reason. When the sheet thickness is changed from k1 to k2, as a sheet is to be transferred from an impression cylinder 10b to a coater double-diameter blanket cylinder 22, the sheet is scratched. To prevent this, as the sheet thickness k is changed, the phase angle of the coater double-diameter blanket cylinder 22 is changed from α1 to α2.

The conversion table 268b shows the relationship “between the phase angle α of the motor 35 and the phase angle β of the motor 45”, as shown in FIG. 11B. The controller 267 controls the phase angle β of the motor 45 on the basis of an output from the conversion table 268b which corresponds to the sheet thickness k″ and an output from a potentiometer 48. When the phase angle α of the motor 35 satisfies α=α1, a phase angle β1 of the motor 45 is obtained from the conversion table 268b.

In this manner, as the sheet thickness changes from k1 to k2 and accordingly the phase angle of the motor 35 changes from α1 to α2, the phase angle of the motor 45 is also changed from β1 to β2. Hence, the printing pressure between the coater double-diameter blanket cylinder 22 and an upper blanket cylinder 25 is maintained in the same state before and after the sheet thickness change.

The conversion table 268c shows the relationship “between the phase angle α of the motor 35 and the phase angle γ of the motor 55”, as shown in FIG. 11C. When the coater double-diameter blanket cylinder 22 is adjusted to match the sheet thickness, the printing pressure between the coater double-diameter blanket cylinder 22 and a lower blanket cylinder 29 changes from that obtained before the sheet thickness is adjusted. The controller 267 controls the phase angle γ of the motor 55 on the basis of an output from the conversion table 268c which corresponds to the phase angle α of the motor 35, and an output from a potentiometer 58. When the phase angle α of the motor 35 satisfies α=α1, a phase angle γ1 of the motor 55 is obtained from the conversion table 268c.

In this manner, as the sheet thickness changes from k1 to k2 and accordingly the phase angle of the motor 35 changes from α1 to α2, the phase angle of the motor 45 is also changed from γ1 to γ2. Hence, the printing pressure between the coater double-diameter blanket cylinder 22 and lower blanket cylinder 29 is maintained in the same state before and after the phase angle change.

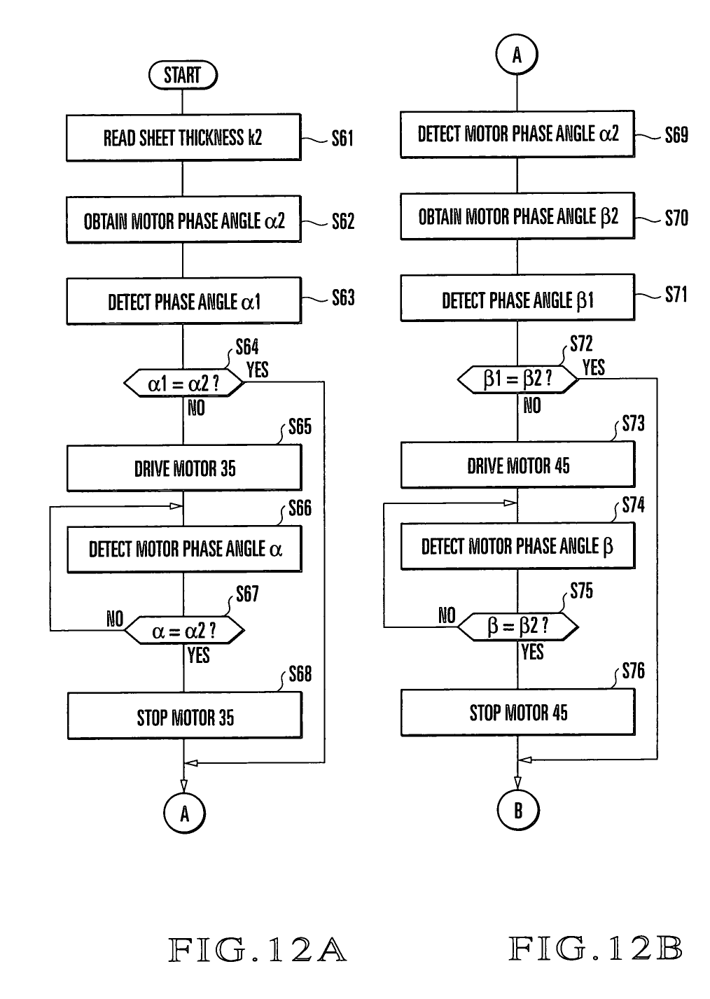

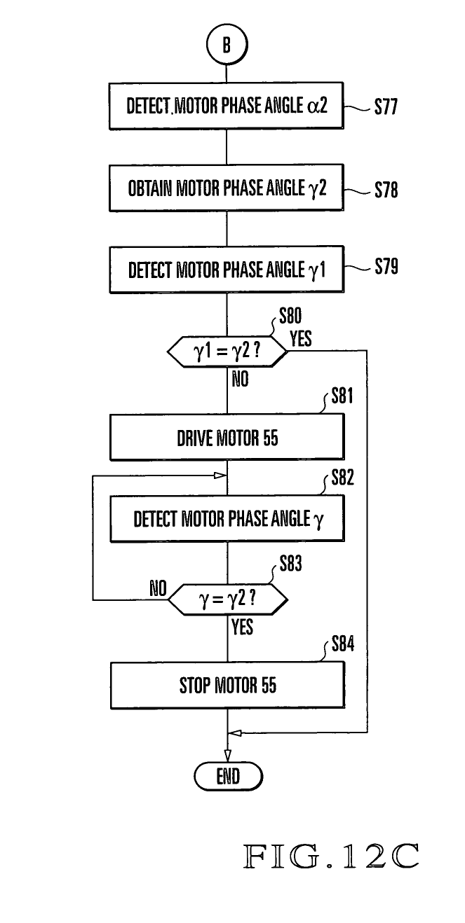

Adjustment and control operation in the second embodiment will be described with reference to FIGS. 12A to 12C. The controller 267 reads the sheet thickness k2 from the sheet thickness input device 66 (step S61). The controller 267 obtains the phase angle α2 of the motor 35 from the sheet thickness k2 by looking up the conversion table 268a (step S62). The controller 267 performs steps S63 to S68 corresponding to steps S3 to S8 shown in FIG. 9A. After performing step S68, the controller 267 performs steps S69 to S76 corresponding to steps S10 to S17 shown in FIG. 9B. After performing step S76, the controller 267 performs steps S77 to S84 corresponding to steps S18 to S25 shown in FIG. 9C.

According to this embodiment, the lower blanket cylinder 29 is positionally adjusted to maintain its printing pressure with respect to the coater double-diameter blanket cylinder 22 which is obtained before position adjustment. According to this embodiment, the position adjustment of the upper blanket cylinder 25 and lower blanket cylinder 29 is performed on the basis of the sheet thickness k input to the sheet thickness input device 66. Alternatively, position adjustment may be controlled on the basis of the phase angle α of the motor 35 which is positionally adjusted on the basis of the sheet thickness k.

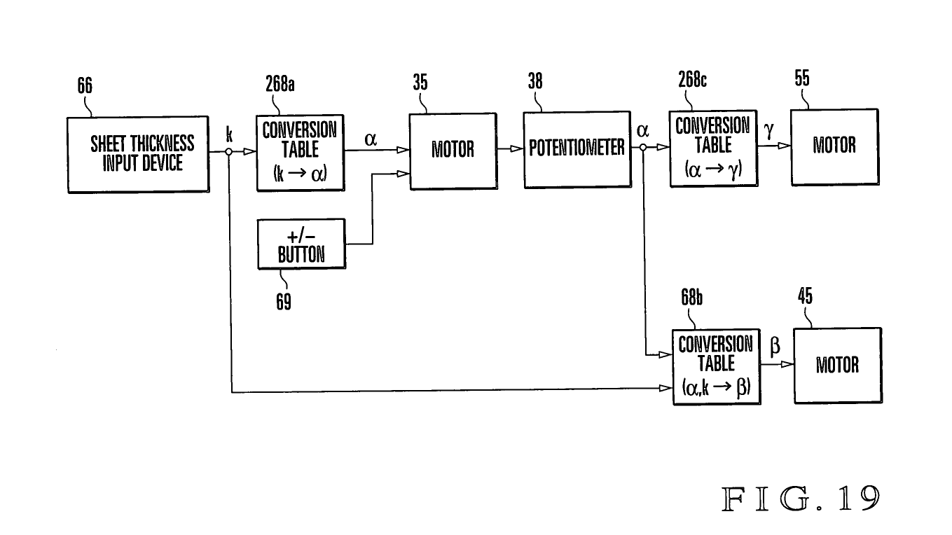

The data sequence of this embodiment will now be described with reference to FIG. 19. In the conversion table 268a, the phase angle α is obtained from the sheet thickness k input to the sheet thickness input device 66. The motor 35 is driven to have the phase angle α obtained from the conversion table 268a. Upon detecting that the motor 35 has the phase angle α, the potentiometer 38 outputs the phase angle α to the conversion tables 268b and 268c.

In the conversion table 268b, the phase angle β is obtained from the phase angle α detected by the potentiometer 38 and the sheet thickness k input from the sheet thickness input device 66. In the conversion table 268c, the phase angle γ is obtained from the phase angle α detected by the potentiometer 38. The motors 45 and 55 are driven to have the phase angles β and γ obtained from the conversion tables 268b and 268c, respectively. The +/− button 69 is manipulated to finely adjust the phase angle α of the motor 35 in the +direction. In this case, the potentiometer 38 detects the finely adjusted phase angle α of the motor 35, and the phase angles β and γ are obtained from the conversion tables 268b and 268c, respectively. The motors 45 and 55 are driven to have the phase angles β and γ, respectively.

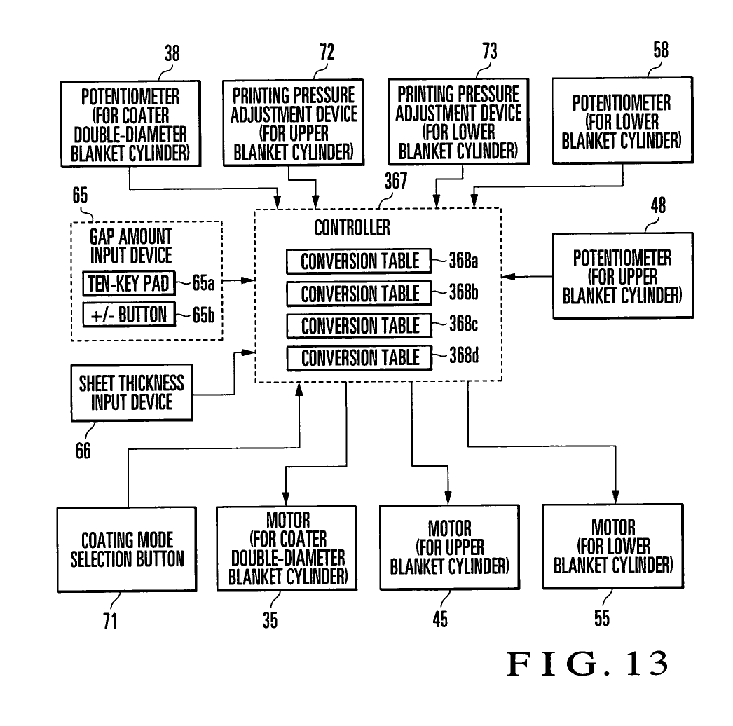

The third embodiment of the present invention will be described with reference to FIGS. 13 to 15D. According to this embodiment, the driving amount of the motor 45 is controlled by adding the amount of printing pressure adjustment of the motor 45, which accompanies adjustment of the printing pressure between a coater double-diameter blanket cylinder 22 and upper blanket cylinder 25 that takes place before the gap amount adjustment, to the driving amount of a motor 45 obtained on the basis of a phase angle α of a motor 35 which is adjusted by gap adjustment. The driving amount of a motor 55 is controlled by adding the amount of printing pressure adjustment of the motor 55, which accompanies adjustment of the printing pressure between the coater double-diameter blanket cylinder 22 and a lower blanket cylinder 29 that takes place before gap amount adjustment, to the driving amount of the motor 55 obtained on the basis of the phase angle α of the motor 35 which is adjusted by gap adjustment.

As shown in FIG. 13, this embodiment further comprises a coating mode selection button 71, a printing pressure adjustment device 72 for the upper blanket cylinder, and a printing pressure adjustment device 73 for the lower blanket cylinder, in addition to the arrangement of the first embodiment. The coating mode selection button 71 (coating mode selection means) performs selection among double-sided coating, reverse coating, and obverse coating. The printing pressure adjustment device 72 drives the motor 45 in accordance with the +/− manipulation of the operator to adjust the printing pressure between the coater double-diameter blanket cylinder 22 and upper blanket cylinder 25. The printing pressure adjustment device 73 drives the motor 55 in accordance with the +/− manipulation of the operator to adjust the printing pressure between the coater double-diameter blanket cylinder 22 and lower blanket cylinder 29.

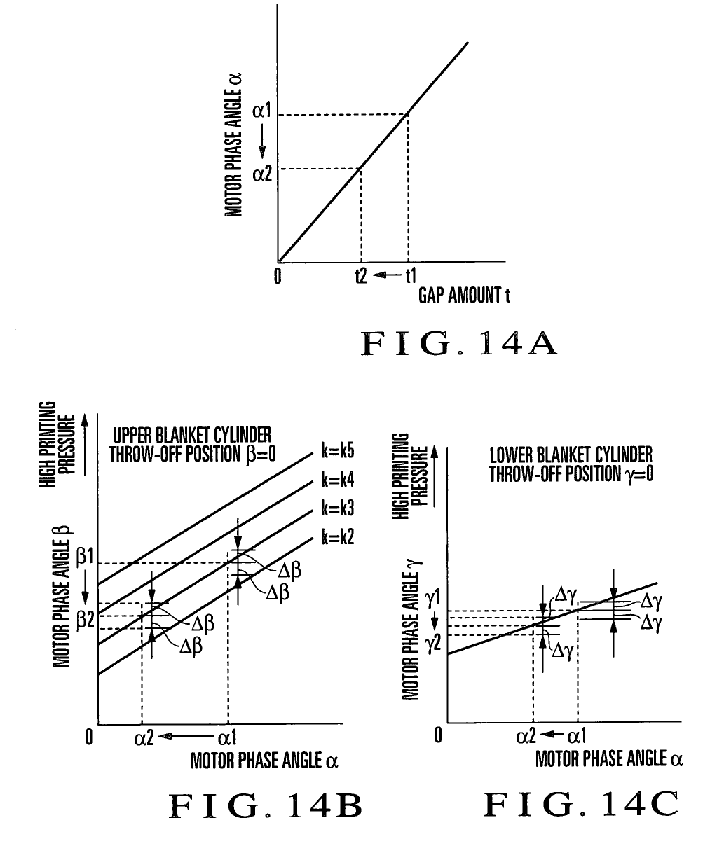

A controller 367 has a first conversion table 68a defining the relationship “between a gap amount t and the phase angle α of the motor 35” shown in FIG. 14A, a second conversion table 368b defining the relationship “between the phase angle α of the motor 35 and a phase angle β of the motor 45 with respect to a sheet thickness k” shown in FIG. 14B, a third conversion table 368c defining the relationship “between the phase angle α of the motor 35 and a phase angle γ of the motor 55” shown in FIG. 14C, and a fourth conversion table 68d defining the relationship “between the sheet thickness k and gap amount t” which is similar to that shown in FIG. 8D.

The controller 367 obtains the gap amount t from the sheet thickness k input to a sheet thickness input device 66 by looking up the conversion table 68d, and outputs the gap amount t to a gap amount input device 65. The controller 367 obtains the phase angle α of the motor 35 from the gap amount t input to the gap amount input device 65 by looking up the conversion table 68a. The controller 367 obtains the phase angle β of the motor 45 from the phase angle α of the motor 35 and the sheet thickness k input to the sheet thickness input device 66 by looking up the conversion table 368b. At this time, the controller 367 adds (by addition or subtraction) an amount corresponding to a printing pressure adjustment amount Δβ, which is adjusted by the printing pressure adjustment device 72 when the motor 45 has a phase angle β1, to a phase angle β2 obtained after adjustment.

More specifically, when the sheet thickness satisfies k=k3 and the phase angle of the motor 35 is α1, the phase angle β1 of the motor 45 is temporarily obtained. At this time, the printing pressure adjustment amount Δβ obtained by the printing pressure adjustment device 72 is added to the phase angle β1. Subsequently, when the phase angle of the motor 35 is changed from α1 to α2, the phase angle β2 of the motor 45 is temporarily obtained. The printing pressure adjustment amount Δβ obtained before the change is added to the temporarily obtained phase angle β2, thus obtaining a phase angle (β2+Δβ).

If the phase angle (β2+Δβ) is adjusted by Δβ in a direction to decrease the printing pressure, Δβ has a negative value, and accordingly a phase angle obtained by subtracting Δβ from β2 is obtained. If the phase angle (β2+Δβ) is adjusted by Δβ in a direction to increase the printing pressure, Δβ has a positive value, and accordingly a phase angle obtained by adding Δβ to β2 is obtained.

In this manner, upon the change of the phase angle of the motor 35 from α1 to α2, the phase angle of the motor 45 is changed from β1 to β2. At this time, the printing pressure adjustment amount which is adjusted before the change is added to the printing press between the coater double-diameter blanket cylinder 22 and upper blanket cylinder 25 which is obtained after the change, thus maintaining the printing pressure in the same state.

The controller 367 obtains the phase angle γ of the motor 55 from the phase angle α of the motor 35 by looking up the conversion table 368c. At this time, the controller 367 adds a printing pressure adjustment amount Δγ, which is obtained by adjusting a phase angle γ1 of the motor 55 by the printing pressure adjustment device 73, to a phase angle γ2 obtained after the adjustment.

More specifically, when the phase angle of the motor 35 is α1, the phase angle γ1 of the motor 55 is temporarily obtained. At this time, the printing pressure adjustment amount Δγ obtained by the printing pressure adjustment device 73 is added to the phase angle γ of the motor 55. Subsequently, when the phase angle of the motor 35 is changed from α1 to α2, the phase angle γ2 of the motor 55 is temporarily obtained. The printing pressure adjustment amount Δγ is added to the temporarily obtained phase angle γ2 of the motor 55, thus obtaining a phase angle (γ2+Δγ) of the motor 55.

In this manner, upon the change of the phase angle of the motor 35 from α1 to α2, the phase angle of the motor 55 is changed from γ1 to γ2. At this time, the printing pressure adjustment amount which is adjusted before the change is added to the printing press between the coater double-diameter blanket cylinder 22 and lower blanket cylinder 29 which is obtained after the change, thus maintaining the printing pressure in the same state.

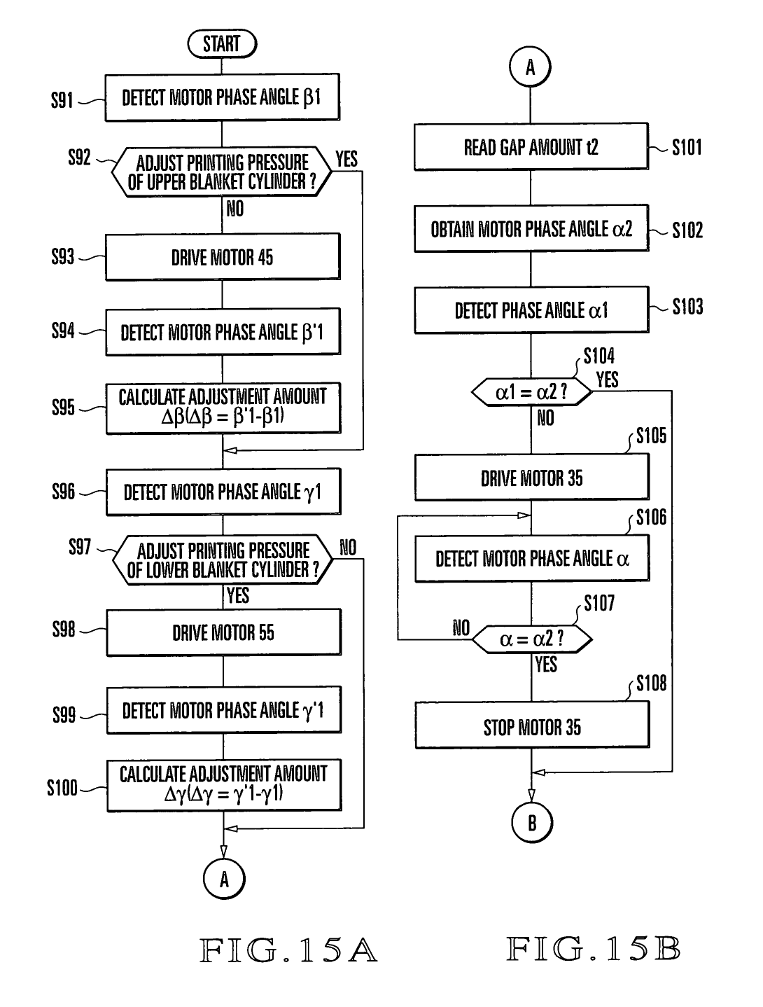

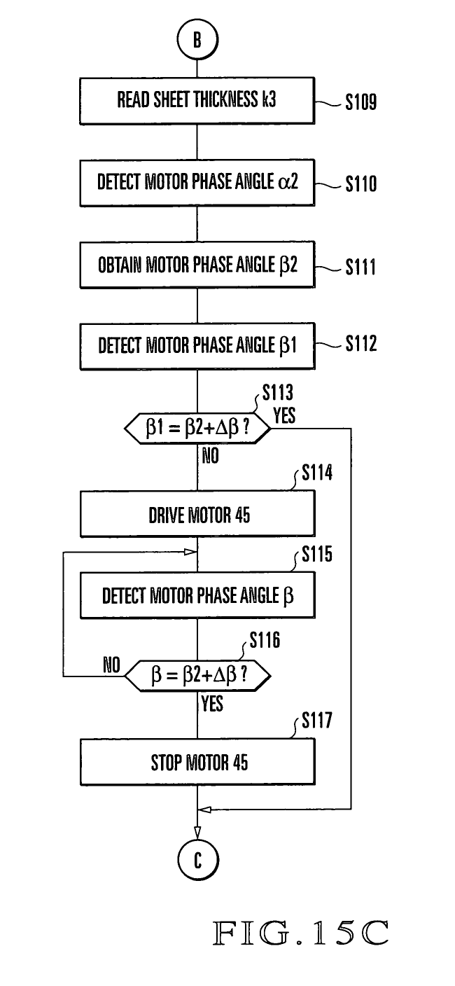

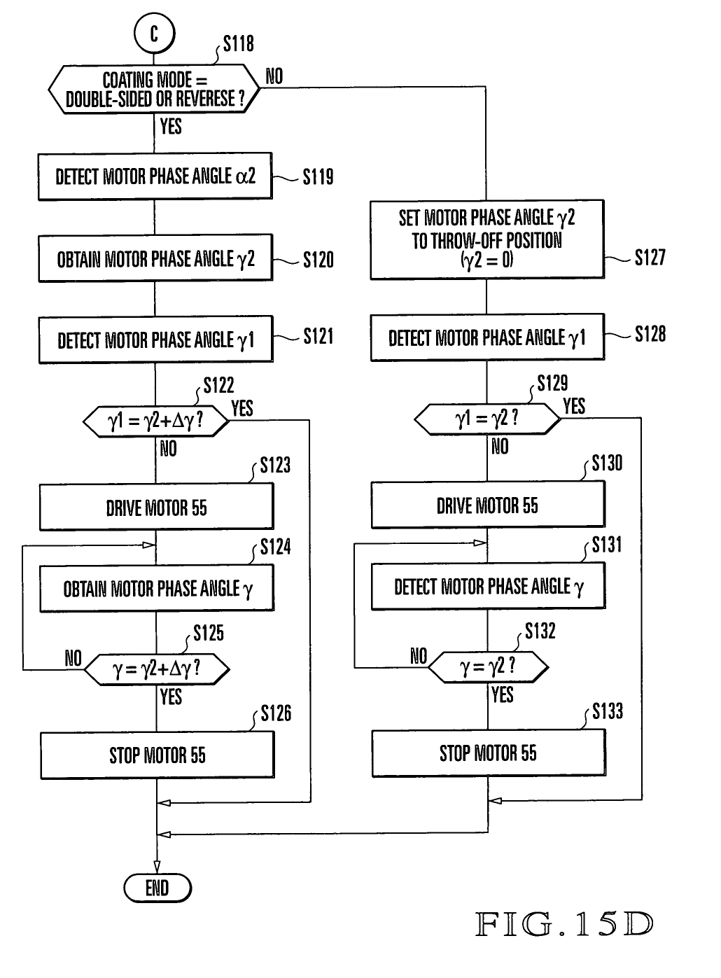

The adjustment and control operation of the third embodiment will be described with reference to FIGS. 15A to 15D. The controller 367 detects the phase angle β1 of the motor 45 on the basis of an output from a potentiometer 48 (step S91). The operator then determines whether or not to adjust the printing pressure between the upper blanket cylinder 25 and coater double-diameter blanket cylinder 22 by the printing pressure adjustment device 72 (step S92).

If printing pressure adjustment is not necessary, the process advances to step S96. If printing pressure adjustment is necessary, the controller 367 drives the motor 45 to perform adjustment (step S93). Then, a phase angle β′1 of the upper blanket cylinder 25 is detected on the basis of the output from the potentiometer 48 (step S94). The amount Δβ=β′1−β1 of printing pressure adjustment for the upper blanket cylinder 25 which is to be performed by the printing pressure adjustment device 72 is calculated (step S95). The phase angle γ1 of the lower blanket cylinder 29 is detected on the basis of an output from a potentiometer 58 (step S96).

The operator then determines whether or not to adjust the printing pressure between the lower blanket cylinder 29 and coater double-diameter blanket cylinder 22 by the printing pressure adjustment device 73 (step S97). If printing pressure adjustment is not necessary, the process advances to step S101. If printing pressure adjustment is necessary, the motor 55 is driven to perform adjustment (step S98). Then, a phase angle γ′1 of the lower blanket cylinder 29 is detected on the basis of the output from the potentiometer 58 (step S99). The amount Δγ=γ′1−γ1 of printing pressure adjustment for the lower blanket cylinder 29 which is to be performed by the printing pressure adjustment device 73 is calculated (step S100).

Subsequently, the controller 367 performs steps S101 to S110 corresponding to steps S1 to S10 shown in FIGS. 9A and 9B. The controller 367 obtains the phase angle β2 of the motor 45 from the sheet thickness k3 and the phase angle α2 of the motor 35 by looking up the conversion table 368b (step S111). Then, the controller 367 detects the current phase angle β1 of the motor 45 on the basis of the output from the potentiometer 48 (step S112).

The controller 367 compares the current phase angle β1 of the motor 45 with (β2+Δβ) which is obtained by adding the adjustment amount Δβ, input from the gap amount input device 65, to the phase angle β2 of the motor 45 obtained from the phase angle α2 of the motor 35 and the sheet thickness k=k3 (step S113). If β1=β2+Δβ, the phase angle β of the motor 45 is a value obtained by adding the adjustment amount Δβ to the phase angle β2 obtained from the phase angle α2 of the motor 35. Thus, the motor 45 is not driven, and the process advances to step S118.

If NO in step S113, the controller 367 performs steps S114 to S117 corresponding to steps S14 to S17 shown in FIG. 9B. In step S116, whether or not the phase angle β=β2+Δβ is checked.

The controller 367 checks whether or not double-sided coating or reverse coating is selected by the coating mode selection button 71 (step S118). If the double-sided coating or reverse coating mode is selected, the controller 367 detects the phase angle α2 of the motor 35 controlled through steps S104 to S108 on the basis of the output from the potentiometer 38 (step S119). The controller 367 then obtains the phase angle γ2 of the motor 55 from the phase angle α2 of the motor 35 by looking up the conversion table 368c (step S120).

Subsequently, the controller 367 detects the current phase angle γ1 of the motor 55 on the basis of the output from the potentiometer 58 (step S121). Then, the controller 367 compares the current phase angle γ1 of the motor 55 with (γ2+Δγ) which is obtained by adding the adjustment amount Δγ, input from the gap amount input device 65, to the phase angle γ2 of the motor 55 obtained from the phase angle α2 of the motor 35 (step S122). If γ1=γ2+Δγ, the phase angle γ of the motor 55 is a value obtained by adding the adjustment amount Δγ to the phase angle γ2 calculated from the phase angle α2 of the motor 35. Thus, the motor 55 is not driven, and the control operation is ended.

If NO in step S122, the controller 367 performs steps S123 to S126 corresponding to steps S22 to S25 shown in FIG. 9C. In step S125, whether or not the phase angle γ=γ2+Δγ is checked.

If not the double-sided or reverse coating mode but the obverse coating mode is selected (NO in step S118), the lower blanket cylinder 29 is set at the throw-off position, i.e., at a position corresponding to the phase angle γ2=0 of the motor 55. Then, the controller 367 performs steps S128 to S133 corresponding to steps S20 to S25 shown in FIG. 9C, and the control operation is ended.

The first to third embodiments has exemplified a case in which the phase angle β of the motor 45 and the phase angle γ of the motor 55 are obtained on the basis of the phase angle α of the motor 35 detected by the potentiometer 38. Alternatively, the phase angles β and γ may be obtained from the conversion tables 68b, 68c, 268b, 268c, 368b, and 368c on the basis of α obtained from the conversion tables 68a and 268a.

In FIG. 7 (the first embodiment), FIG. 10 (the second embodiment), and FIG. 13 (the third embodiment), the sheet thickness input device 66 is exemplified by a ten-key input device to which the operator inputs the sheet thickness k manually. Alternatively, a sheet thickness measurement device which measures the thickness of the sheet before printing automatically may be used.

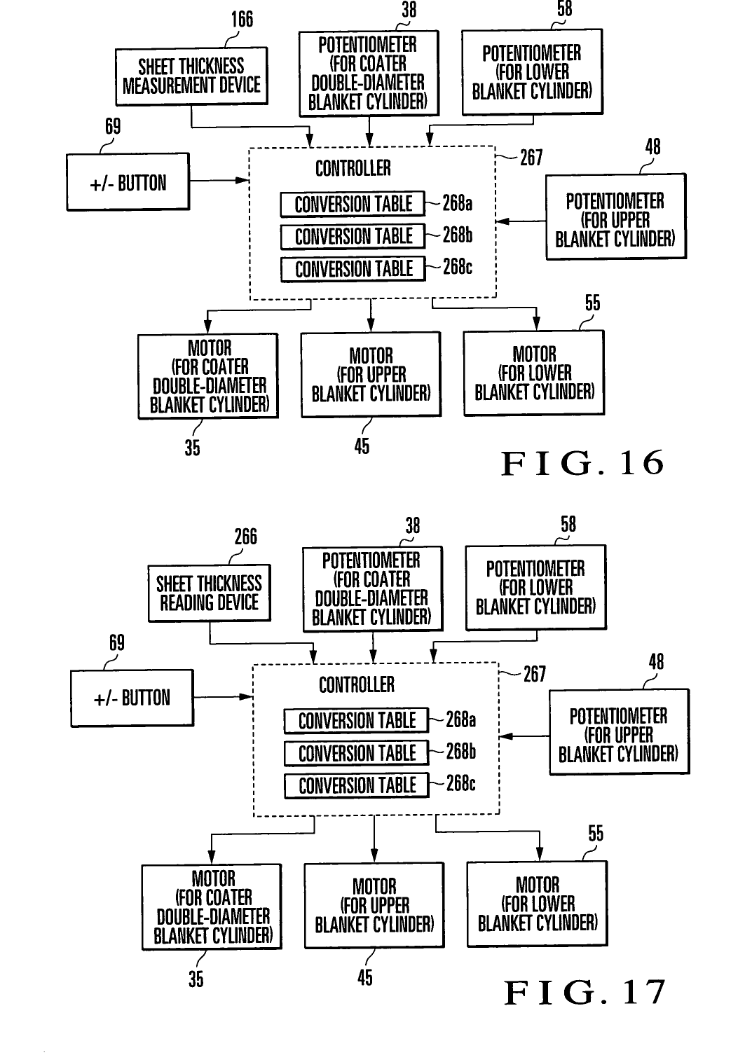

FIG. 16 shows the fourth embodiment of the present invention which uses a sheet thickness measurement device. This embodiment comprises a sheet thickness measurement device 166 in place of the sheet thickness input device 66 in FIG. 10. A controller 267 controls motors 35, 45, and 55 on the basis of the measurement result of the sheet thickness measurement device 166.

In FIG. 7 (the first embodiment), FIG. 10 (the second embodiment), and FIG. 13 (the third embodiment), the sheet thickness input device 66 is exemplified by a ten-key input device to which the operator inputs the sheet thickness k manually. Alternatively, a sheet thickness reading device which reads a barcode formed on a sheet before printing or code information stored in an IC tag prepared for each sheet lot may be used.

FIG. 17 shows the fifth embodiment of the present invention which uses a sheet thickness reading device. This embodiment comprises a sheet thickness reading device 266 in place of the sheet thickness input device 66 in FIG. 10. A controller 267 controls motors 35, 45, and 55 on the basis of the readout result of the sheet thickness reading device 266.

In the above embodiments, if α1=α2 is not satisfied in steps S4, S64, and S104, the motor 35 is driven so that α=α2 is obtained by repeating steps S5 to S7, S65 to S67, and S105 to S107. However, the present invention is not limited to this. If α1=α2 is not satisfied, α1−β2 may be calculated to obtain the difference, and the motor 35 may be driven by an amount corresponding to the difference.

Similarly, if β1=β2 is not satisfied in steps S13 and S70, β1−β2 may be calculated to obtain the difference, and the motor 45 may be driven by an amount corresponding to the difference. Similarly, if γ1=γ2 is not satisfied in steps S21 and S76, γ1−γ2 may be calculated to obtain the difference, and the motor 55 may be driven by an amount corresponding to the difference.

In the above embodiments, the coater double-diameter blanket cylinder 22, upper blanket cylinder 25, and lower blanket cylinder 29 of the coating unit 4 are described. The same explanation may be applied to the impression cylinders 10a and 10b and blanket cylinders 11a and 11b in the printing unit 3. Three conversion tables are used to obtain the phase angles of the motors 35, 45, and 55. The motor phase angles may be calculated by using calculation equations in place of the conversion tables.

As has been described above, according to the present invention, when transferring a sheet from the transport cylinder to the first cylinder, if the sheet is scratched depending on the thickness or material of the sheet, the controller drives the first driving means to adjust the gap amount between the first cylinder and transport cylinder. Not only adjustment can be performed within a short period of time, but also the load to the operator can be reduced and the productivity can be improved.

As the gap amount between the first cylinder and the upstream transport cylinder is adjusted, the second and third driving means are driven to adjust the printing pressures of the second and third cylinders. This enables adjustment to maintain the printing quality to complete within a short period of time. This can also decrease waste paper.

What is claimed is:

1. A sheet processing apparatus comprising:
a first cylinder which receives a sheet from an upstream transport cylinder and holds the sheet;
a second cylinder which is disposed to oppose said first cylinder and prints/coats the sheet held by said first cylinder;
a third cylinder which is disposed to oppose said first cylinder and supplies ink/varnish to a circumferential surface of said first cylinder;
first driving means for adjusting a gap amount between said first cylinder and said upstream transport cylinder;
second driving means for adjusting a position of said second cylinder with respect to said first cylinder;
third driving means for adjusting a position of said third cylinder with respect to said first cylinder; and
control means for controlling said second driving means and said third driving means when said first driving means adjusts the gap amount between said first cylinder and said upstream transport cylinder.

2. An apparatus according to claim 1, wherein said control means controls said second driving means and said third driving means such that a printing pressure between said first cylinder and said second cylinder before gap amount adjustment and a printing pressure between said first cylinder and said third cylinder before gap amount adjustment are maintained after gap amount adjustment.

3. An apparatus according to claim 1, further comprising detection means for detecting a current position of said first cylinder,
wherein said control means controls said second driving means and said third driving means in accordance with a detection output from said detection means.

4. An apparatus according to claim 3, further comprising gap amount input means for inputting the gap amount between said first cylinder and said upstream transport cylinder,
wherein said control means controls said first driving means in accordance with the gap amount from said gap amount input means, and
said detection means detects the current position of said first cylinder after said first driving means performs gap amount adjustment.

5. An apparatus according to claim 4, wherein said control means controls said second driving means and said third driving means in accordance with a detection output of said detection means after said first driving means performs gap amount adjustment.

6. An apparatus according to claim 4, further comprising a table defining a relationship between the gap amount and the position of said first cylinder,
wherein said control means controls said first driving means in accordance with the gap amount obtained from said table.

7. An apparatus according to claim 3, further comprising thickness input means for inputting a thickness of the sheet,
wherein said control means controls said first driving means in accordance with the sheet thickness from said thickness input means, and
said detection means detects the current position of said first cylinder after said first driving means performs gap amount adjustment.

8. An apparatus according to claim 7, wherein said control means controls said second driving means and said third driving means in accordance with a detection output from said detection means after said first driving means performs gap amount adjustment.

9. An apparatus according to claim 7, further comprising a table defining a relationship between the thickness of the sheet and the position of said first cylinder,
wherein said control means controls said first driving means in accordance with a thickness of the sheet obtained from said table.

10. An apparatus according to claim 3, wherein said control means controls
said second driving means in accordance with a current position of said second cylinder and an adjustment position for said second cylinder which is detected by said detection means, and
said third driving means in accordance with a current position of said third cylinder and an adjustment position for said third cylinder which is detected by said detection means.

11. An apparatus according to claim 3, wherein said detection means comprises a potentiometer which detects the current position of said first cylinder.

12. An apparatus according to claim 1, wherein said upstream transport cylinder comprises an impression cylinder.

13. An apparatus according to claim 1, further comprising process mode selection means for selecting a process mode for the sheet among a double-sided mode of printing/coating two surfaces of the sheet, an obverse mode of printing/coating only an obverse of the sheet, and a reverse mode of printing/coating only a reverse of the sheet,
wherein said control means controls said third driving means in accordance with the process mode selected by said process mode selection means.

14. An apparatus according to claim 13, wherein when the process mode is one of the double-sided mode and the reverse mode, said control means controls said third driving means such that the third cylinder comes into contact with said first cylinder, and when the process mode is the obverse mode, said control means controls said third driving means such that said third cylinder separates from said first cylinder.

15. An apparatus according to claim 1, further comprising
a first coating device which includes said second cylinder and coats one surface of the sheet held by said first cylinder, and
a second coating device which includes said first cylinder and said third cylinder and coats the other surface of the sheet held by said first cylinder.

16. An apparatus according to claim 15, wherein said first coating device and said second coating device further include a chamber coater.

17. An apparatus according to claim 15, wherein
said upstream transport cylinder comprises an impression cylinder, and
the sheet held by said impression cylinder is subjected to printing on the other surface thereof.

18. An apparatus according to claim 1, further comprising
a printing unit including at least one obverse printing unit including a first impression cylinder which holds and conveys the sheet and a first transfer cylinder which is disposed to oppose said impression cylinder and prints an obverse of the sheet held by said impression cylinder, and at least one reverse printing unit including a second impression cylinder which holds and conveys the sheet and a second transfer cylinder which is disposed to oppose said impression cylinder and prints a reverse of the sheet held by said impression cylinder, and
a coating unit which includes said first cylinder, said second cylinder, and said third cylinder and coats the obverse/reverse of the sheet, printed by said printing unit, with varnish,
wherein said first cylinder and said second cylinder are disposed to oppose each other, and
said first cylinder is arranged to oppose one of said first impression cylinder and said second impression cylinder.

19. An apparatus according to claim 1, wherein said first cylinder, said second cylinder, and said third cylinder are supported rotatably by an eccentric bearing.
